(19) United States
(12) Patent Application Publication
(10) Pub. No.: US 2021/0245496 A1
(43) Pub. Date: Aug. 12, 2021

(54) FLUIDIC DEVICE WITH NOZZLE LAYER HAVING CONDUCTIVE TRACE FOR DAMAGE DETECTION

(71) Applicant: Hewlett-Packard Development Company, L.P., Spring, TX (US)

(72) Inventors: James R Przybyla, Corvallis, OR (US); Chien-Hua Chen, Corvallis, OR (US); Michaei G Groh, Corvallis, OR (US)

(73) Assignee: Hewlett-Packard Development Company, L.P., Spring, TX (US)

(21) Appl. No.: 17/251,238

(22) PCT Filed: Jan. 31, 2019
(86) PCT No.: PCT/US2019/016073

§ 371 Date: Dec. 11, 2020

(51) Int. Cl. B41J 2/045; B41J 2/14

(52) U.S. Cl. CPC B41J 2/0451; B41J 2/04586; B41J 2/14153

(57) ABSTRACT

One example provides a fluidic device including a substrate and a nozzle layer disposed on the substrate, the nozzle layer having an upper surface opposite the substrate and including a plurality of nozzles formed therein, each nozzle including a fluid chamber and a nozzle orifice extending through the nozzle layer from the upper surface to the fluid chamber. A conductive trace is disposed in direct contact with the nozzle layer and extending proximate to a portion of the nozzle orifices, the conductive trace having an electrical property indicative of damage to the nozzle layer.

### BACKGROUND

Fluidic devices, such as fluidic dies, for example, include a nozzle layer (e.g., an SU8 layer) in which a plurality of nozzles may be formed, with each nozzle including a fluid chamber and a nozzle orifice extending from a surface of the nozzle layer to the fluid chamber and through which fluid drops may be ejected from the fluid chamber. Some example fluidic devices may be printheads, where a fluid within the fluid chambers may be ink.

### BRIEF DESCRIPTION OF THE DRAWINGS

FIG. 1 is a cross-sectional view generally illustrating a fluidic die, according to one example.

FIGS. 2A-2D generally illustrate ejection of a fluid drop from a fluidic die, according to one example.

FIG. 3 is a cross-sectional view generally illustrating a fluidic die, according to one example.

FIG. 4 is a cross-sectional view generally illustrating a fluidic die, according to one example.

FIG. 5 is a top cross-sectional view generally illustrating an arrangement of a conductive trace, according to one example.

FIG. 6 is a top cross-sectional view generally illustrating an arrangement of a conductive trace, according to one example.

FIG. 7 is a top cross-sectional view generally illustrating an arrangement of a conductive trace, according to one example.

FIG. 8 is a top cross-sectional view generally illustrating an arrangement of a conductive trace, according to one example.

FIG. 9 is a cross-sectional view generally illustrating a fluidic die, according to one example.

FIG. 10 is a block and schematic diagram generally illustrating a printhead including a fluidic die, according to one example.

FIG. 11 is a flow diagram generally illustrating a method of detection damage to a fluidic die, according to one example.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples of fluidic devices, such as fluidic dies, for instance, may include fluid actuators. Fluid actuators may include thermal resistor based actuators, piezoelectric membrane based actuators, electrostatic membrane actuators, mechanical/impact driven membrane actuators, magneto-strictive drive actuators, or other suitable devices that may cause displacement of fluid in response to electrical actuation. Example fluidic dies described herein may include a plurality of fluid actuators, which may be referred to as an array of fluid actuators. An actuation event or firing event, as used herein, may refer to singular or concurrent actuation of fluid actuators of a fluidic die to cause fluid displacement.

Example fluidic dies may include fluid channels, fluid chambers, orifices, and/or other features which may be defined by surfaces fabricated in a substrate and other material layers of the fluidic die such as by etching, microfabrication (e.g., photolithography), micromachining processes, or other suitable processes or combinations thereof. Some example substrates may include silicon-based substrates, glass-based substrates, gallium-arsenide-based substrates, and/or other such suitable types of substrates for microfabricated devices and structures.

As used herein, fluid chambers may include ejection chambers in fluidic communication with nozzle orifices from which fluid may be ejected, and fluidic channels through which fluid may be conveyed. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

In some examples, a fluid actuator may be arranged as part of a nozzle where, in addition to the fluid actuator, the nozzle includes an ejection chamber in fluidic communication with a nozzle orifice. The fluid actuator is positioned relative to the fluid chamber such that actuation of the fluid actuator causes displacement of fluid within the fluid chamber that may cause ejection of a fluid drop from the fluid chamber via the nozzle orifice. Accordingly, a fluid actuator arranged as part of a nozzle may sometimes be referred to as a fluid ejector or an ejecting actuator.

In one example nozzle, the fluid actuator comprises a thermal actuator, where actuation of the fluid actuator (sometimes referred to as “firing”) heats fluid within the fluid chamber to form a gaseous drive bubble therein, where such drive bubble may cause ejection of a fluid drop from the fluid chamber via the nozzle orifice (after which the drive bubble collapses). In one example, the thermal actuator is spaced from the fluid chamber by an insulating layer. In one example, a cavitation plate may disposed within the fluid chamber, where the cavitation plate is positioned to protect material underlying the fluid chamber, including the underlying insulating material and fluid actuator, from cavitation forces resulting from generation and collapse of the drive bubble. In examples, the cavitation plate may be metal (e.g., tantalum). In some examples, the cavitation plate may be in contact with the fluid within the fluid chamber.

In some examples, a fluid actuator may be arranged as part of a pump where, in addition to the fluidic actuator, the pump includes a fluidic channel. The fluidic actuator is positioned relative to a fluidic channel such that actuation of the fluid actuator generates fluid displacement in the fluid channel (e.g., a microfluidic channel) to convey fluid within the fluidic die, such as between a fluid supply (e.g., fluid slot) and a nozzle, for instance. A fluid actuator arranged to convey fluid within a fluidic channel may sometimes be referred to as a non-ejecting actuator. In some examples, similar to that described above with respect to a nozzle, a metal cavitation plate may be disposed within the fluidic channel above the fluid actuator to protect the fluidic actuator and underlying materials from cavitation forces resulting from generation and collapse of drive bubbles within the fluidic channel.

Fluidic dies may include an array of fluid actuators (such as columns of fluid actuators), where the fluid actuators of the array may be arranged as fluid ejectors (i.e., having corresponding fluid ejection chambers with nozzle orifices) and/or pumps (having corresponding fluid channels), with selective operation of fluid ejectors causing fluid drop ejection and selective operation of pumps causing fluid displacement within the fluidic die.

Fluid dies may include a nozzle layer (e.g., an SU8 photoresist layer) disposed on a substrate (e.g., a silicon substrate) with the fluid chamber and nozzle orifice of each nozzle being formed in the nozzle layer. In one example, the SU8 layer has first surface (e.g., a lower surface) disposed on the substrate (facing the substrate), and an opposing second surface (e.g., an upper surface) facing away from the substrate. In one example, the fluid chambers of each nozzle are formed within the nozzle layer, with the fluid chambers being disposed below the upper surface, and with a corresponding nozzle orifice extending through the nozzle layer from the upper surface to each fluid chamber, where fluid drops (e.g., ink drops) may be ejected from the fluid chambers via the corresponding nozzle orifice.

During operation, the nozzle layer may become cracked or otherwise damaged, such as through contact with imaging media, for example. Such damage may cause fluid leakage from the fluid chambers and adversely affect fluid ejection quality, and is a common cause of fluidic die failure. However, the occurrence of such damage is unpredictable and difficult to detect and, as such, may result in fluid leakage and undesirable output for a long period of time.

Present techniques for detecting such damage include scanning printed output for defects and drop detection techniques (e.g., electrical, optical). However, scanning printed output is expensive and time consuming, and drop detection techniques are limited in the types of defects that are detectable.

According to examples of the present disclosure, a conductive trace is disposed in contact with the nozzle layer, with an electrical property of the conductive trace being indicative of whether the nozzle layer is damaged. For instance, according to one example, a resistance of the conductive trace is monitored, such as by monitoring circuitry integral to the fluidic die or external to the fluidic die, to provide realtime indication as to whether the nozzle layer is damaged (e.g., cracked). In one example, multiple conductive traces may be monitored to pinpoint damaged locations for trouble shooting purposes.

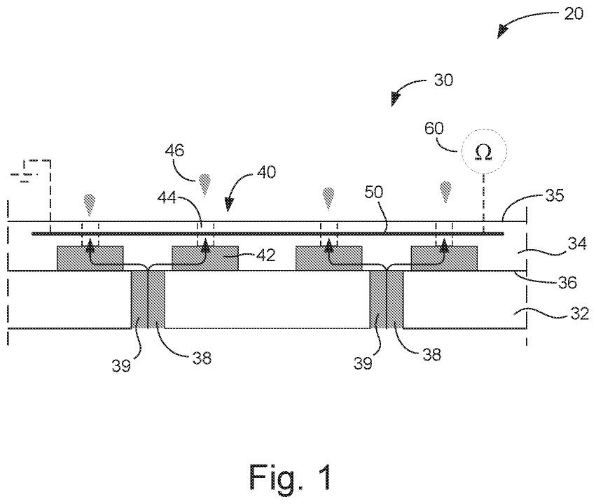

FIG. 1 is a cross-sectional view generally illustrating portions of a fluidic device 20, such as a fluidic die 30, including a conductive trace disposed in contact with a nozzle layer, in accordance with one example of the present application. According to the example of FIG. 1, fluidic die 30 includes a substrate 32, such as a silicon substrate, with a nozzle layer 34 disposed thereon. In example, nozzle layer 34 has a first surface 36 (e.g., a lower surface) disposed on substrate 32, and an opposing second surface 35 (e.g., an upper surface). In one example, nozzle layer 34 comprises an SU-8 material.

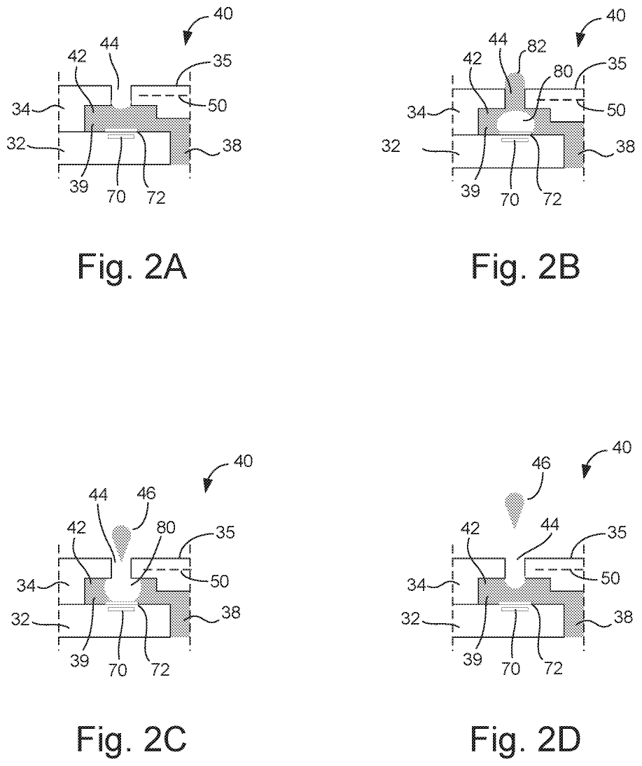

Nozzle layer 34 includes a plurality of nozzles 40 formed therein, with each nozzle 40 including a fluid chamber 42 disposed within nozzle layer 34 and a nozzle orifice 44 extending through the nozzle layer 34 from upper surface 35 to fluid chamber 42. In one example, substrate 32 includes a plurality of fluid feed holes 38 to supply fluid 39 (e.g., ink) from a fluid source to fluid chambers 42 of nozzles 40. In operation, nozzles 40 selectively eject fluid drops 46 from fluid chamber 42 via nozzle orifices 44 (see FIGS. 2A-2D below).

As described above, during operation, nozzle layer 34 may become damaged (e.g., cracked) such the ejection of fluid drops 46 from one or more of nozzles 40 may be adversely impacted. In one example, fluidic die 30 includes a conductive trace 50 disposed in direct contact with nozzle layer 34, where an electrical property of conductive trace 50 is indicative of whether nozzle layer 34 is damaged. In one case, such electrical property may be an impedance of conductive trace 50. In another case, such electrical property may be a resistance of conductive trace 50. In other cases, such electrical property may be a capacitance of conductive trace 50 (where conductive trace 50 includes a pair of parallel conductive segments).

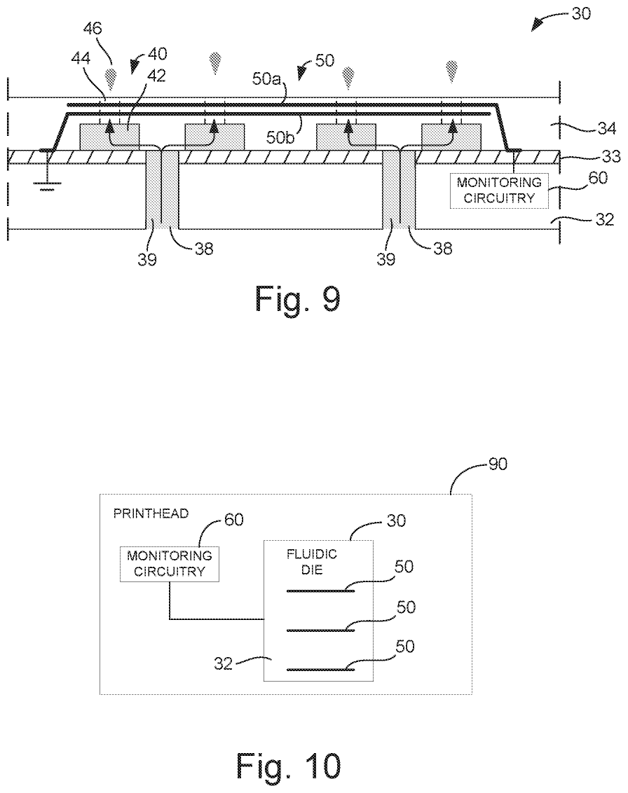

In one example, as illustrated, conductive trace 50 is embedded within nozzle layer 34. In one example, conductive trace 50 may be disposed on the surface of nozzle layer 34. Conductive trace 50 may be made of any suitable conductive material, including Al, Cr/Au, Ta, Ti, and doped polysilicon, for example. In one example, conductive trace 50 is a continuous conductive trace extending proximate to a group of nozzles 40, where an impedance of conductive trace 50 is indicative of whether nozzle layer 34 is damaged (e.g., an increase in a known impedance level of conductive trace 50 may be indicative of damage to nozzle layer 50, such as a crack, for instance). In one other examples, conductive trace 50 may comprise a pair of parallel conductive traces which together form a capacitor (see FIG. 9), with a capacitance being indicative of whether nozzle layer 34 is damaged.

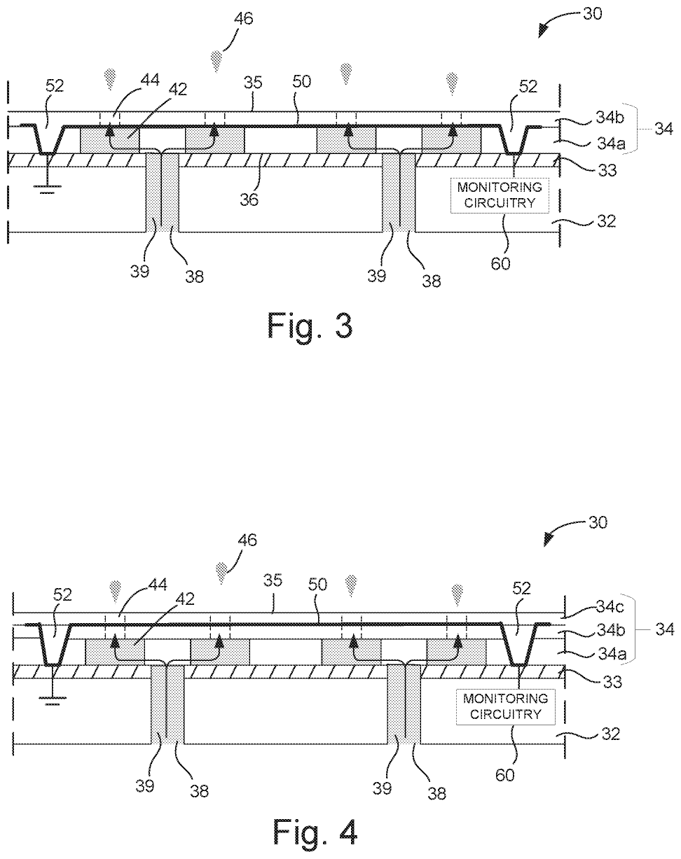

In one case, monitoring circuitry 60 (e.g., generally illustrated as an ohmmeter in FIG. 1) may be connected to conductive trace 50 for monitoring the corresponding electrical property thereof, such as an impedance, for example. In one case, monitoring circuitry 60 may be external to fluidic die 30, as indicated by the dashed lines in FIG. 1. In other cases, monitoring circuitry 60 may be integrated within fluidic die 30, such as an integrated circuit within substrate 32, for example (e.g., see FIG. 3).

In one example, conductive trace 50 is a continuous conductive trace extending proximate to a group of nozzles 40. Although only a single conductive trace 50 is illustrated in FIG. 1, it is noted that, in other examples, multiple conductive traces 50 may be disposed in contact with nozzle layer, with each conductive trace 50 disposed proximate to a different group of nozzles 40 so as to provide indication of damage to different portions of nozzle layer 34.

By periodically monitoring an electrical property of a conductive trace disposed in direct contact with the nozzle layer (e.g., embedded therein), the condition of the nozzle layer can be monitored in real time. Such real time monitoring provides early detection of nozzle layer damage, thereby enabling defective fluidic devices to be quickly identified which, in-turn, reduces downtime and potentially reduces an amount of defective output (e.g., printed output).

FIGS. 2A-2D are cross-sectional views generally illustrating a nozzle 40, according to one example, and generally illustrating ejection of a fluid drop therefrom. Nozzle 40 of FIGS. 2A-2D includes a thermal actuator 70, such as a thermal resistor, for example, to vaporize fluid to form a drive bubble within fluid chamber 42 to eject a drop 46 during a firing event. In the illustrated example, nozzle 40 further includes a cavitation plate 72 disposed on a bottom surface of fluid chamber 42 so as to be positioned above thermal actuator 70. As mentioned above, cavitation plate 72 protects thermal actuator 70 and material underlying fluid chamber 42 from cavitation forces created by drive bubble collapse.

With reference to FIG. 2A, prior to an actuation event, when thermal actuator 70 is not energized, fluid chamber 42 is filled with fluid 39, such as ink for example. Upon initiation of an actuation event, as illustrated by FIG. 2B thermal actuator 70 is energized and begins heating fluid 39, causing vaporization of at least a portion of a component of fluid 39 (e.g., water) and to begin formation of a vapor or drive bubble 80 within fluid chamber 42, where the expanding drive bubble 80 begins to force a portion 82 of fluid 39 from fluid chamber 42 via nozzle orifice 44.

With reference to FIG. 2C, as thermal actuator 70 continues to heat fluid 39, drive bubble 80 continues to expand until it escapes from nozzle orifice 44 and expels portion 82 of fluid 39 therefrom in the form a fluid drop 46. With reference to FIG. 2D, upon ejection of fluid drop 46, thermal actuator is de-energized and drive bubble 80 collapses as fluid drop 46 continues to move away from nozzle orifice 44. Upon completion of the firing event, nozzle 40 returns to a state as illustrated by FIG. 2A.

As described above, if nozzle layer 34 becomes damaged, such damage may adversely impact the ability of nozzles 40 to properly eject fluid drops 46, and may cause leakage and puddling of fluid 39 on upper surface 35 of fluidic die 30.

FIG. 3 is a cross-sectional view generally illustrating portions of fluidic die 30, in accordance with one example of the present application. According to the example of FIG. 3, a thin film layer 33, including a plurality of metal wiring layers, is disposed between nozzle layer 34 and substrate 32. Additionally, nozzle layer 34 includes multiple layers, including a chamber layer 34a in which fluid chamber 42 are formed, and a nozzle orifice layer 34b in which nozzle orifices 44 are formed.

According to the example of FIG. 3, conductive trace 50 is disposed between chamber layer 34a and nozzle orifice layer 34b (e.g., on top of chamber layer 34a). In this example, conductive trace 50 is electrically connected at each end to metal layers within thin film layer 33 by vias 52 extending through chamber layer 34a to thin film layer 33, with a first end and an opposing second end of conductive trace 50 being respectively connected to monitoring circuitry 60 integral to substrate 32 and to a reference potential (e.g., ground) by way of thin film layer 33. In one example, monitoring circuitry 60 monitors an impedance of conductive trace 50 by injecting a fixed current through conductive trace 50 with a resulting voltage being representative of the impedance. In other cases, monitoring circuitry 60 may apply a fixed voltage to conductive trace 50 with a resulting current being representative of the impedance of conductive trace 50. In one example, monitoring circuitry 60 may compare the measured impedance of conductive trace 50 to a known or expected impedance of conductive trace 50, with a measured impedance greater than the expected impedance being indicative of damage to nozzle layer 34.

In another example, as illustrated by FIG. 4, fluidic die 30 is similar to that illustrated by FIG. 3, except that, in addition to chamber layer 34a and nozzle orifice layer 34b, nozzle layer 34 further includes a cap layer 34c disposed on top of nozzle orifice layer 34b. According to the example of FIG. 4, conductive trace 50 is disposed on a top surface of nozzle orifice layer 34b and is covered by cap layer 34c, with conductive trace 50 being connected to thin film layer 33 by vias 52 extending through nozzle orifice layer 34b and chamber layer 34a. In one example, which is not illustrated, conductive trace 50 may be disposed on the top surface of nozzle orifice layer 34b without being covered by cap layer 34c.

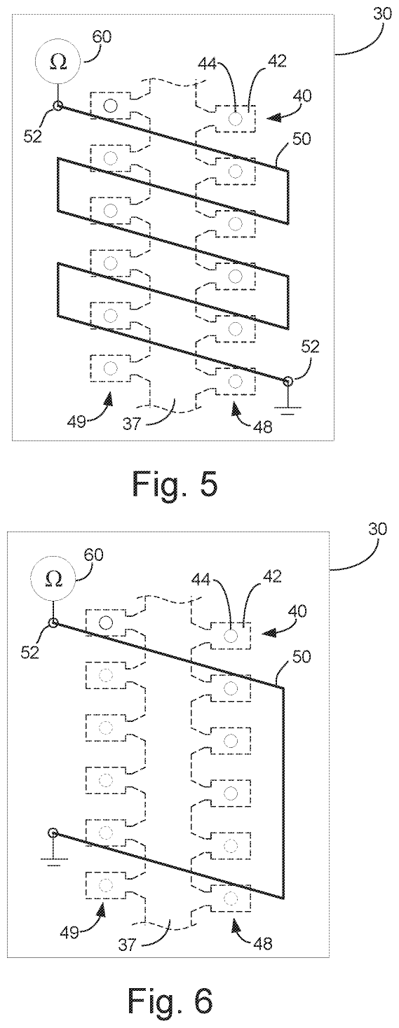

FIGS. 5-8 each generally illustrate a top cross-sectional view of a portion of fluidic die 30, and generally illustrate example configurations of conductive trace 50 within nozzle layer 34. In each of the FIGS. 5-8, underlying fluid chambers 42 and an underlying fluid feed slot 37 to supply fluid (e.g., ink) to fluid chambers 42 are illustrated in dashed lines, with nozzles 40 being arranged in columns 48 and 49 along each side of fluid feed slot 37. In other examples, an array of fluid feed holes may be employed in lieu of a fluid feed slot.

In the example of FIG. 5, conductive trace 50 continuously extends in a serpentine fashion in nozzle layer 34 so as to be disposed proximate to each nozzle 40 of a portion of nozzles of each of the columns 48 and 49, with a first end being connected to monitoring circuitry 60 (e.g., within substrate 32) and an opposing second end being connected to ground through respective vias 200 through nozzle layer 34.

In the example of FIG. 6, conductive trace 50 is a continuous conductive trace which extends laterally at intervals across columns 48 and 49 (e.g., between every fourth pair of adjacent nozzle orifices 44 the columns) and longitudinally along one of the columns proximate to nozzle orifices, with opposing ends coupled by way of vias 200 to monitoring circuitry 60 and ground (or other reference potential). The configuration of FIG. 6 is similar to that of FIG. 5, except that conductive trace 50 does not extend proximate to every nozzle orifices 44 of columns 48 and 49.

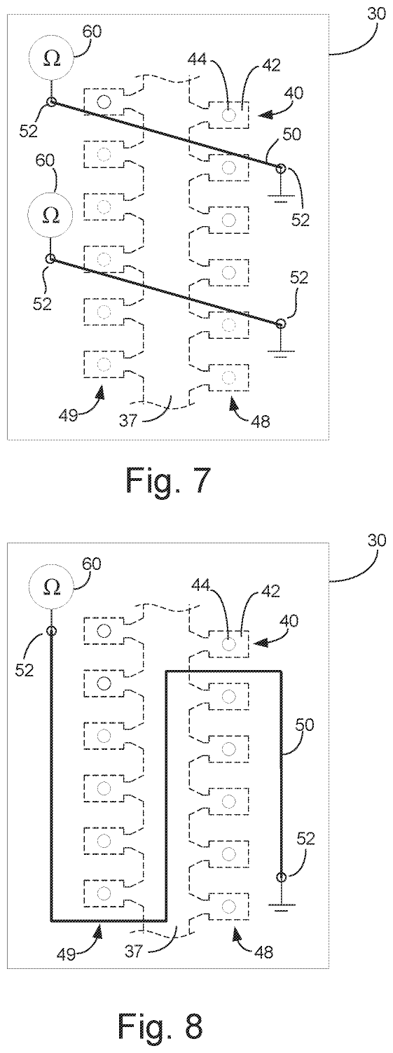

In the example of FIG. 7, multiple conductive traces 50 extend across columns 48 and 49 at intervals (e.g., every fourth pair of nozzle orifices 44), with each conductive trace 50 being individually connectable to monitoring circuitry 60. In the example of FIG. 8, a continuous conductive trace 50 extends longitudinally along each side of a portion of nozzle orifices 44 of each of the columns 48 and 49.

It is noted that the configurations of FIGS. 5-8 are for illustrative purposes, and that any number of potential configurations of conductive traces 50 are possible. In one example, a number of continuous serpentine shaped conductive traces 50, such as illustrated by FIG. 5, are disposed in nozzle layer 34, with each conductive trace providing damage detection for a different portion of the nozzle orifices 44 of nozzles 40. By employing multiple conductive traces 50 on a fluidic die 30, a particular location of damage to nozzle layer 34 may be determined.

FIG. 9 is a cross-sectional view illustrating portions of fluidic die 30, according to one example, where in lieu of conductive trace 50 being a single continuous conductive trace, conductive trace includes a pair of spaced apart conductive traces 50a and 50b which together form a capacitor disposed within nozzle layer 34, with one end of conductive trace 50a being connected to monitoring circuitry 60 by a via 52 extending through nozzle layer 34 to thin film layer 33, and one end of conductive trace 50b being connected to a reference potential (e.g. ground) by a via 52 extending through nozzle layer 34 to thin film layer 33. In one example, monitoring circuitry 60 applies a voltage across measures a capacitance of conductive traces 50a and 50b by applying a voltage across conductive traces 50a and 50b and measuring a resulting current, where the measured capacitance is indicative of whether nozzle layer 34 is damaged.

In one example, as illustrated, monitoring circuitry 60 is integrated within substrate 32 such monitoring circuitry 60 and conductive traces 50a and 50b together provide fluidic die 32 with an integrated nozzle layer damage detection circuit. In other examples, monitoring circuitry 60 may be disposed remotely from fluidic die 32.

FIG. 10 is a block and schematic diagram generally illustrating a printhead 90 including a fluidic die 30 having a plurality of conductive traces 50 disposed in nozzle layer 32, and further including monitoring circuitry 60 disposed external to fluidic die 30. In one example, monitoring circuit 60 may be integrated within fluidic die 30. In other examples, printhead die 90 may include multiple fluidic die 30, with externally disposed monitoring circuitry 60 to monitor the electrical property of the conductive traces 50 of each of the fluidic die 30. In other examples, printhead 90 may be part of a printer, where printhead 90 provides indication of a status of conductive traces 50 and fluidic die 30 to the printer.

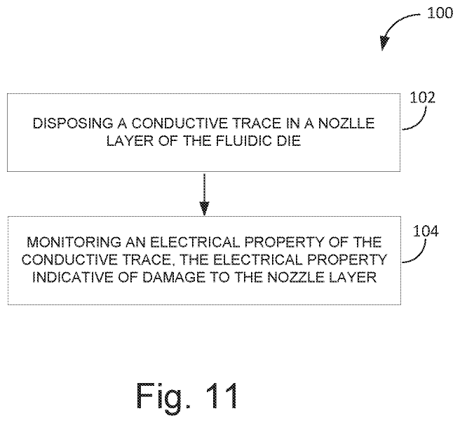

FIG. 11 is a flow diagram generally illustrating an example of a method 100 of damage detection for a fluidic die, such as fluidic die 30 of FIG. 3. At 102, method 100 includes disposing a conductive trace in a nozzle layer, the conductive trace extending proximate to a group of nozzle orifices of a plurality of nozzles formed in the nozzle layer, such as conductive trace 50 embedded in nozzle layer 34 and extending proximate to a group of nozzle orifices 44 in FIG. 3 and FIG. 5, for example. At 104, the method including monitoring an electrical property of the conductive trace, the electrical property indicative of damage to the nozzle layer, such as monitoring circuitry 60 monitoring an impedance value of conductive trace 50 of FIG. 3 or monitoring an capacitance of a capacitor formed by parallel segments 50a and 50b of conductive trace 50 of FIG. 9, for example. In one example, a variation of a measured value of the electrical property varies from an expected or known value (e.g., varies by more than a predetermined amount) indicates damage to the nozzle layer.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A fluidic device comprising:
a substrate;
a nozzle layer disposed on the substrate and having an upper surface opposite the substrate, the nozzle layer including a plurality of nozzles formed therein, each nozzle including a fluid chamber and a nozzle orifice extending through the nozzle layer from the upper surface to the fluid chamber; and
a conductive trace disposed in direct contact with the nozzle layer and extending proximate to a portion of the nozzle orifices, the conductive trace having an electrical property indicative of damage to the nozzle layer.

2. The fluidic device of claim 1, the conductive trace embedded within the nozzle layer.

3. The fluidic device of claim 1, the conductive trace disposed on the upper surface of the nozzle layer.

4. The fluidic device of claim 1, the conductive trace being a continuous conductive trace, the electrical property being one of an impedance and a resistance of the conductive trace.

5. The fluidic device of claim 1, the conductive trace comprising a pair of conductive traces extending in parallel with one another, the electrical property being a capacitance of a capacitor formed by the parallel conductive traces.

6. The fluidic device of claim 1, including a monitoring circuit to monitor the electrical property of the conductive trace.

7. The fluidic device of claim 6, the monitoring circuit integrated in the substrate.

8. The fluidic device of claim 1, including a plurality of conductive traces, each conductive trace extending proximate to a portion of nozzle orifices of the plurality of nozzles.

9. The fluidic device of claim 1, the fluidic device comprising a fluidic die.

10. The fluidic device of claim 1, including a wiring layer disposed between the nozzle layer and the substrate, the conductive trace electrically connected to the wiring layer by vias extending through the nozzle layer to the wiring layer.

11. A printhead comprising:
a fluidic die including:
a substrate;
a nozzle layer disposed on the substrate and having an upper surface opposite the substrate, the nozzle layer including a plurality of nozzles formed therein, each nozzle including a fluid chamber and a nozzle orifice extending through the nozzle layer from the upper surface to the fluid chamber; and
a conductive trace disposed in direct contact with the nozzle layer and extending proximate to a portion of the nozzle orifices; and
a monitoring circuit to monitor a value of the electrical property of the conductive trace, the value the electrical property indicative of damage to the nozzle layer.

12. A method of damage detection for a fluidic die including:
disposing a conductive trace in a nozzle layer, the conductive trace extending proximate to a group of nozzle orifices of a plurality of nozzles formed in the nozzle layer; and
monitoring an electrical property of the conductive trace, the electrical property indicative of damage to the nozzle layer.

13. The method of claim 12, the monitoring including:
measuring a value of the electrical property; and
comparing the measured value of the electrical property to a known value, a deviation of the measured value from the known value being indicative of damage to the nozzle.

14. The method of claim 12, including integrating a monitoring circuit within a substrate of the fluidic die for monitoring the electrical property.

15. The method of claim 12, the electrical property being one of an impedance and a capacitance.
